(19) United States
(12) Patent Application Publication
(10) Pub. No.: US 2007/0151677 A1
(43) Pub. Date: Jul. 5, 2007

(54) Reinforcement system and method for sectional overhead doors

(76) Inventors: A. Anthony East, East Bend, NC (US); Danny L. Joyner, Clemmons, NC (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/326,240

(22) Filed: Jan. 5, 2006

(51) Int. Cl. E05D 15/00

(52) U.S. Cl. 160/209

(57) ABSTRACT

A reinforcement system for a sectional overhead door includes a post having a lower end, and an anchor for removably connecting the lower end of the post to a floor. The anchor includes an L-bracket configured to be removably attached to the lower end of the post, and a horizontal leg. An eyebolt removably attaches the horizontal leg of the L-bracket to the floor, and is movably attached to the post. A plurality of door brackets configured for attachment to the door panels each include a selectively positionable clevis pin removably extending through portions of the bracket. A plurality of cables having first and second ends are configured to be removably engaged around the clevis pin of one of the door brackets when the cable is wrapped around the vertical post. The reinforcement system is configured to permit the system to be installed and removed without tools.

### FIELD OF THE INVENTION

The invention relates to reinforcement systems and methods for articulated overhead doors for reinforcing such doors against high wind and pressure loads, and more particularly relates to a vertical post reinforcement system that can be readily and easily adapted to overhead doors and installed in and removed from a doorway without tools.

### BACKGROUND

Sectional overhead garage doors commonly are used to cover large entryways of residential garages and other structures. Such doors typically are constructed of a plurality of pivotally interconnected door panels with rollers that travel in guide tracks mounted on the sides and above the inside frame of an entryway. In order to facilitate ease of operation, such doors commonly include articulated door panels that are constructed of lightweight materials such as thin-gauge steel or other metal, plastic, fiberglass, and the like. Such panels typically include an integral frame structure that provides the panels with acceptable strength and rigidity under normal conditions.

During extreme weather conditions, however, high wind and pressure loads can cause substantial distortion, buckling, and damage to such lightweight door panels and doors. For example, such lightweight overhead sectional doors can become distorted and forced from their guide tracks in gusting hurricane-force winds and under sudden air pressure differentials created by strong storms. Accordingly, at least in areas that are subject to hurricanes or other periodic violent storms, there is a need for an apparatus and method that temporarily reinforces an overhead door of typical lightweight construction to increase the door's strength and rigidity such that the doors are capable of withstanding high wind and pressure loads with minimal damage and without dislodgement.

Various methods and devices are known for reinforcing sectional overhead doors of conventional lightweight construction. For example, horizontal reinforcement struts can be affixed to the inside surfaces of one or more door panels to increase the overall strength and stiffness of the door panel(s) and doors. Such struts typically have deep cross-sections that make the struts strong and stiff. Because these struts necessarily include relatively deep cross-sections, the struts can substantially increase the overall depth of the door panels to which they are connected. In addition, because the depth of horizontal reinforcement struts can vary, the overall depths of doors having reinforcement struts can vary significantly.

Others have developed vertical post reinforcement systems that include vertical posts or beams installed in an entryway behind a closed sectional door. Such systems typically include at least one rigid vertical post that has a lower end removably anchored to a floor, and an upper end that is removably attached to a header above an entryway. One or more of the door panels are connected to the installed vertical post by links, wire cables, or the like. These removable vertical posts are installed in an entryway when high wind and pressure loads are expected, thereby adding substantial strength and rigidity to the door system. Such vertical post reinforcement systems may be used alone, or in combination with horizontal reinforcement struts as described above.

When using a vertical post to reinforce a sectional overhead door against high wind and pressure loads, the system preferably secures the door in close proximity to the post to prevent the door from flexing and rattling under oscillating severe load conditions. Accordingly, where flexible cables are used to connect sectional door panels to a vertical post, the cables preferably tightly wrap around the post with little or no loose slack in the cables when the innermost edges of the door panels or struts attached thereto are snuggly against the post. One problem with known vertical post reinforcement systems is that such systems do not easily accommodate doors having varying overall depths. For example, when cables or links are used to connect the door panels to a vertical post, cables or links of different lengths may be required to tightly hold door panels of different overall depths against the vertical post.

Accordingly, there is a need for a vertical post reinforcement system that simply and adjustably accommodates sectional overhead door panels having various overall depths. For example, an adjustable vertical post reinforcement system is needed that can accommodate both door panels having horizontal reinforcement struts, and those without struts. In addition, there is a need for a vertical post reinforcement system that is relatively easy to install in an entryway, and also is relatively easy to remove from an entryway. In addition, there is a need for a vertical post reinforcement system that includes at least some components that can be permanently installed in an entryway, and that will not interfere with the entryway or operation of the overhead door when the vertical post is not installed.

### SUMMARY

The invention includes an improved vertical post reinforcement system and method for reinforcing a conventional lightweight sectional overhead door against high wind and pressure loads. In one embodiment, the invention includes a reinforcement system for a sectional overhead door having a plurality of pivotally interconnected door panels. The system includes a post having an upper end with an aperture extending therethrough, and a lower end. The system further includes an anchor for removably connecting the lower end of the post to a floor, the anchor including a bracket having a vertical leg configured to be removably attached to the lower end of the post, and a horizontal leg. An eyebolt removably attaches the horizontal leg of the bracket to the floor, and includes an eye. An upper bracket removably connects the upper end of the post to a garage door header. A plurality of door brackets are configured for attachment to the door panels. Each door bracket includes a first wall having at least a pair of first openings therein, and an opposed second wall having at least a pair of second openings therein. A selectively positionable clevis pin removably extends through at least one set of opposed first and second openings. This embodiment of the invention further includes a plurality of cables, each cable having first and second ends configured to be removably engaged around the clevis pin of one of door brackets when the cable is wrapped around the vertical post.

The invention also includes a reinforcement apparatus for a sectional overhead door including a plurality of pivotally interconnected door panels having inner faces. The apparatus includes a vertical post. At least one door panel bracket is configured for attachment to a door panel of the overhead door, and includes a first plate having a plurality of spaced first openings therein, and a second plate in opposed spaced relation to the first plate and having a plurality of spaced second openings therein. A pin removably extends between the first and second plates, and is capable of extending through different pairs of the first and second openings. The pin of each door bracket is capable of being selectively positioned between the first and second plates such that the cross pin is positioned at a selected distance from the inner face of the door panel.

The invention further includes a method of adapting a vertical post reinforcement system to overhead sectional doors having door panels with inner faces and differing overall depths. In one embodiment, the method includes providing a plurality of elongated cables having opposed ends and fixed lengths. The method further includes providing adjustable cable connection means for connecting the cables to the door panels of the overhead sectional door. The adjustable cable connection means permits the ends of the cables to be connected to the door panels at a selected distance from the inner faces of the door panels.

These and other aspects of the invention will be understood from a reading of the following detailed description together with the drawings.

### BRIEF DESCRIPTION OF THE DRAWINGS

FIG. 1 is an environmental perspective view showing one embodiment of a vertical post reinforcement system according to the invention installed in an entryway inside a closed sectional overhead door.

FIG. 2 is a side elevation view showing the vertical post reinforcement system of FIG. 1.

FIG. 3 is a perspective view of a portion of the vertical post reinforcement system of FIGS. 1 and 2 showing attachments between door panels and the vertical post.

FIG. 4 is a top cross-sectional view of the vertical post reinforcement system of FIGS. 1-3 taken along line 4-4 in FIG. 1, showing the system used with a door panel having a deep strut.

FIG. 5 is a top cross-sectional view similar to FIG. 4, showing the system used with a door panel having a more shallow strut.

FIG. 6 is a perspective view of a door panel cable bracket for use in the vertical post reinforcement system shown in FIGS. 1-5.

FIG. 7 is an exploded perspective view of the bracket shown in FIG. 6.

FIG. 8 is a perspective view of a bottom anchor portion of the vertical post reinforcement system of FIGS. 1 and 2.

FIG. 9 is a side elevation view of the bottom anchor portion shown in FIG. 8.

FIG. 10 is a perspective view of a top support portion of the vertical post reinforcement system of FIGS. 1 and 2.

### DETAILED DESCRIPTION

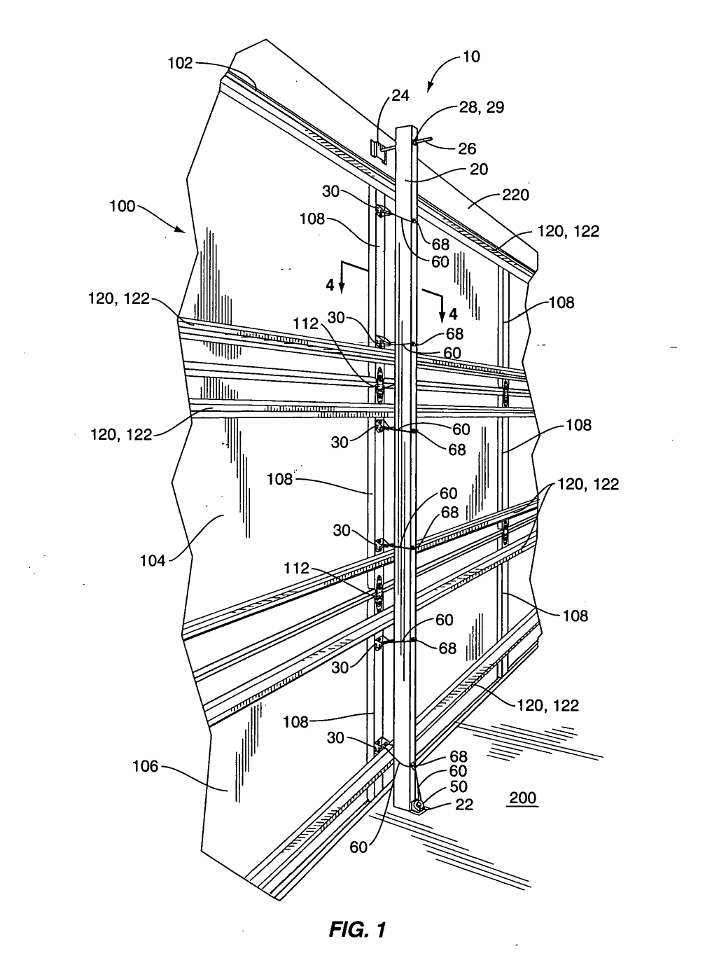

One embodiment of a vertical post reinforcement apparatus 10 according to the invention is shown in FIG. 1. As shown in FIG. 1, the system 10 is used to reinforce a sectional overhead door 100 of the type having a plurality of pivotally interconnected door panels 102, 104, 106 that are movably mounted in an entryway bounded by a floor 200 and a header 220. The door panels 102, 104, 106 include a plurality of stiles 108 that are pivotally connected by a series of hinges 112. The door 100 may include a plurality of horizontal reinforcement struts 120, 122 mounted on the inside faces of the door panels 102, 104, 106. Horizontal reinforcement struts 120, 122 like those shown in FIG. 1 may be used to increase the strength and stiffness of the elongated lightweight door panels, and may be produced in various widths or depths, depending upon the degree of added strength and stiffness that is desired. For example, relatively deep struts 120 may be about three inches deep, and relatively shallow struts 122 may be about two inches deep. Generally, wide doors 100 having wide door panels 102, 104, 106 require deeper struts 120 to sufficiently stiffen the panels, whereas narrower doors 100 are sufficiently stiffened by struts 122 that are relatively shallow. As shown in FIG. 1, the struts 120, 122 inwardly extend from the inner faces 116 of the door panels 102, 104, 106. Though the door 100 shown in the figures includes reinforcement struts 120, 122, a vertical post reinforcement system 10 according to the invention also may be used with a door without struts 120, 122.

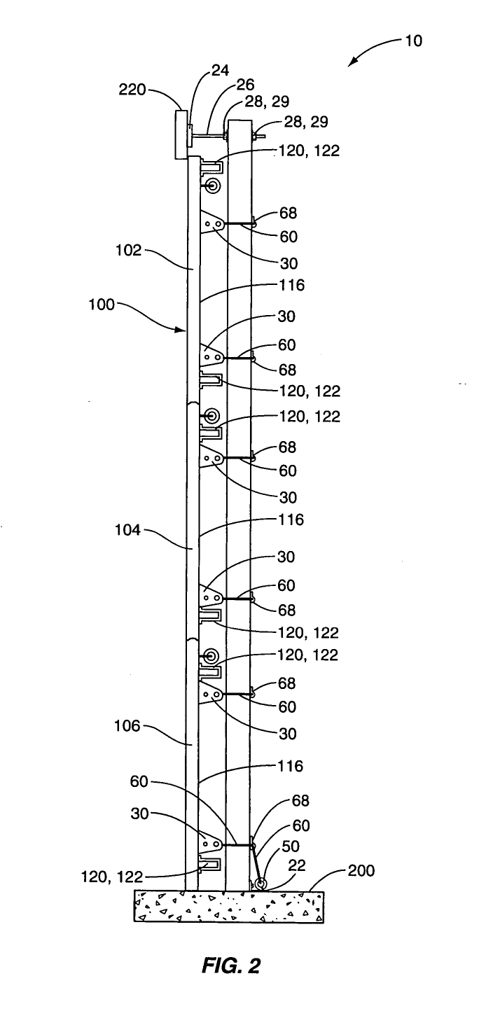

As shown in FIGS. 1 and 2, the vertical post reinforcement system 10 includes an elongated vertical post 20 having a lower end and an upper end. The post 20 extends from the floor 200 to the header 220, and is positioned proximate to the innermost edges of the horizontal struts 120, 122. Alternatively, when used with an overhead door without struts 120, 122, the post 20 can be positioned proximate to inner faces 116 of the door panels 102, 104, 106. When so positioned, the post 20 blocks the inward movement of the door panels 102, 104, 106 and the struts 120, 122 attached thereto, thereby preventing the door 100 from being forced into or through the entryway by outside wind and pressure loads. In addition, a plurality of spaced cables 60 are attached to the door panels 102, 104, 106 by a series of door panel cable brackets 30, and extend around the post 20, thereby binding the door 100 to the post 20. The wrapped cables 60 prevent the door panels 102, 104, 106 from moving outwardly when the air pressure on the inside face of the door 100 exceeds the pressure on the outside of the door 100. The post 20 preferably has a cross-section that provides the post with substantial rigidity. In the embodiment 20 shown, the post 20 is constructed of a suitably strong metal such as steel), and has a hollow rectangular cross-section. For example, the post 20 may be about 7 feet 6 inches tall, about 1½ inches wide, and about 3 inches deep, and may have a wall thickness of about 0.1 inch. The post 20 may be constructed of ASTM A-500 Grade B rectangular structural steel tubing.

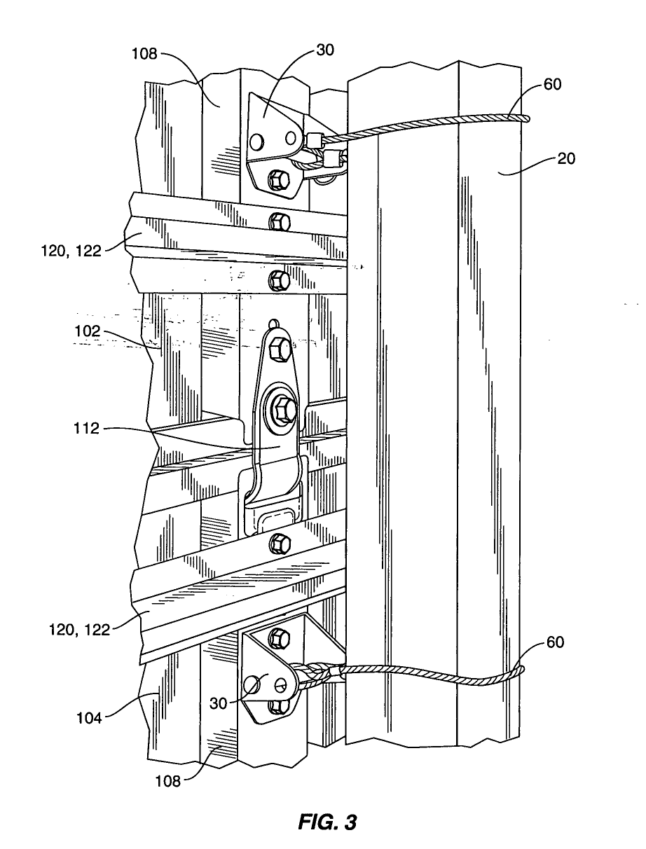

FIG. 3 shows a preferred arrangement for binding the door panels 102, 104, 106 to the post 20 to limit the outward movement of the panels 102, 104 and 106. In this arrangement, a series of door panel cable brackets 30 are affixed to the inside faces of the door panel stiles 108. The brackets 30 may be removably attached to the stiles 108 by one or more threaded fasteners, or the like. In the arrangement shown, one bracket 30 is attached to a stile 108 on a first door panel 102 just above a first horizontal strut 120, 122, and another bracket 30 is attached to a stile 108 on a second door panel 104 just below a second horizontal strut 120, 122, such that the hinge 112 and joint between the door panels 102, 104 is positioned between the upper and lower brackets 30, as shown in FIGS. 1 and 2, a single lowermost cable 60 may be connected to a lower portion of a lowermost door panel 106 by a cable bracket 30 positioned just above a lowermost strut 120, 122.

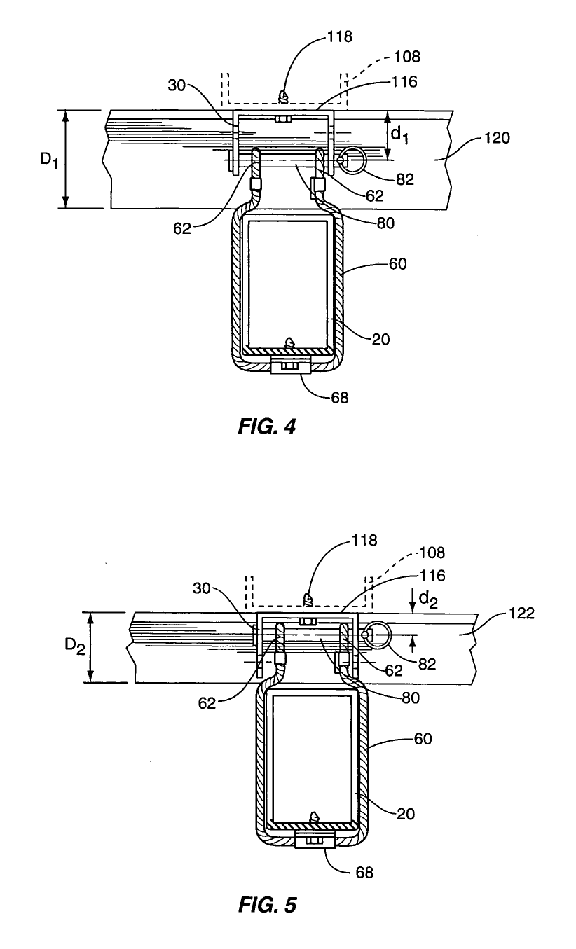

As shown in FIG. 4, each cable 60 extends around the post 20 such that the associated bracket 30 and stile 108 of the door panel are bound to the post 20. Accordingly, the cables 60 limit the outward movement of the door 100 and door panels 102, 104, 106 away from the post 20. The adjacent horizontal strut 120 shown in FIG. 4 has a depth D₁. For a deep strut 120 having this depth, a clevis pin 80 on the bracket 30 is positioned at an innermost position in the bracket 30 that is a distance d₁ from the inner face 116 of the door panel stile 108, such that the cable is wrapped around the post 20 with little or no slack in the cable 60, and such that the post 20 is closely proximate to the innermost edge of the strut 120. The cable 60 preferably has looped ends 62 that receive the clevis pin 80 of the bracket 30, thereby securing the cable 60 around the post 20 and to the bracket 30. A middle portion of the cable 60 may be affixed to the post 20 by a retainer clip 68 as shown, thereby capturing the cable 60 on the post.

FIG. 5 shows a door 100 having a shallow strut 122 bound to the post 20 by a cable 60. The shallow strut 122 has a depth D₂ that is smaller than the depth D₁ of the deep strut 120 shown in FIG. 4. For a door 100 with a shallow strut 122, the clevis pin 80 of the associated bracket 30 is positioned to the inner face 116 of the associated door panel stile 108 at a distance d₂. By providing for selective adjustable positioning of the clevis pin 80 in the bracket 30, identical brackets 30 and cables 60 can be used for closely binding door panels having either deep horizontal struts 120, or shallow horizontal struts 122, to the post 20.

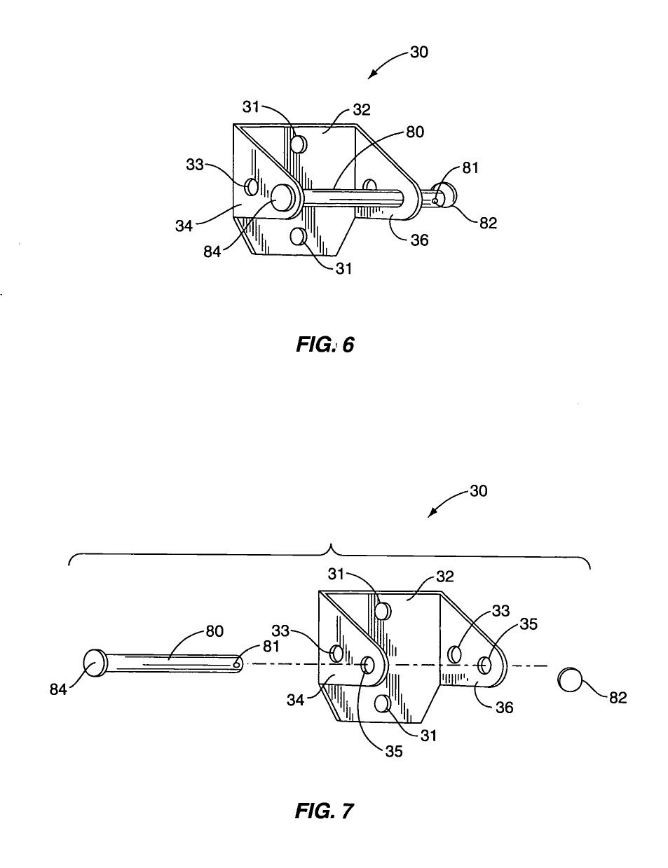

One embodiment of a door panel cable bracket 30 is shown in FIGS. 6 and 7. In this embodiment, the bracket 30 includes a base plate 32, and two inwardly-extending opposed side plates 34, 36. Holes 31 are provided in the base plate to receive threaded fasteners for attaching the bracket 30 to a stile. The side plates 34 and 36 include a first pair of aligned clevis pin holes 33, and a second pair of aligned clevis pin holes 35. The holes 33, 35 are sized to recieve the clevis pin 80. The clevis pin 80 may include a head 84 on a first end, and a cross hole 81 in a second end. Once the clevis pin 80 is inserted in one of the pairs of holes 33 or 35, a retainer 82 is inserted through the hole 81. The retainer 82 and head 84 cooperate to capture the clevis pin 80 between the opposed side plates 34, 36. The retainer 82 may be a split ring, a cotter pin, or any other suitable retaining device.

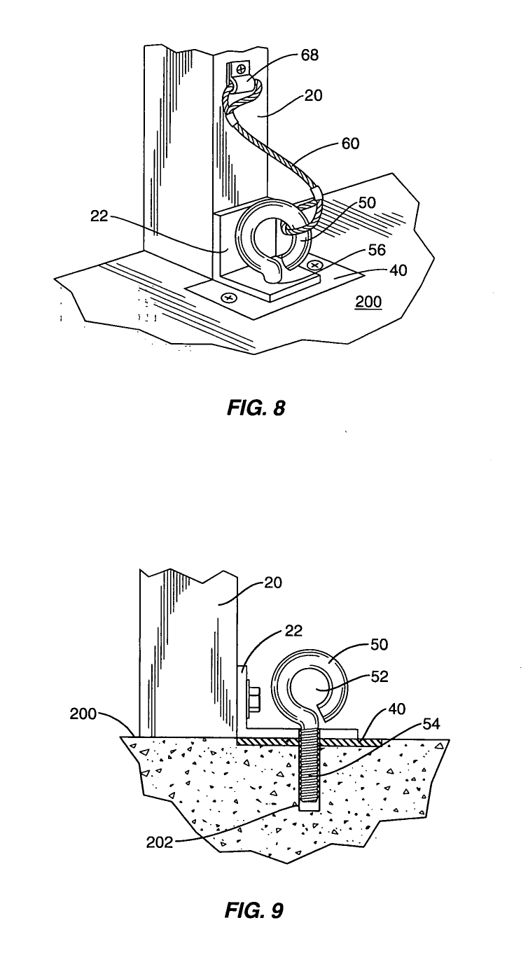

FIGS. 8 and 9 show a preferred arrangement for anchoring the lower end of the post 20 to a floor or foundation 200 inside an entryway. In this arrangement, an L-shaped bracket 22 is attached to a lower face of the post 20 such that one leg of the bracket 22 inwardly extends from the post 20 proximate to the lower end of the post 20. A hole 56 in the bracket 20 is sized to receive the shank 54 of an eyebolt 50. The threaded shank 54 of the eyebolt 50 engages a hole 202 in the floor 200, thereby securing the bracket 22 and post 20 to the floor 200. The eyebolt 50 includes an eye 52 that permits the eyebolt 50 to be easily gripped in a person's hand, and inserted into the hole 202 without tools. As shown in FIG. 8, the eye 52 also permits the eyebolt 50 to be movably connected to the post 20 by a cable 60 and retainer clip 68 such that the eyebolt 50 will not be lost or misplaced. A finishing plate 40 may be provided on the floor 200 around the hole 202 to provide the floor 200 with a finished appearance.

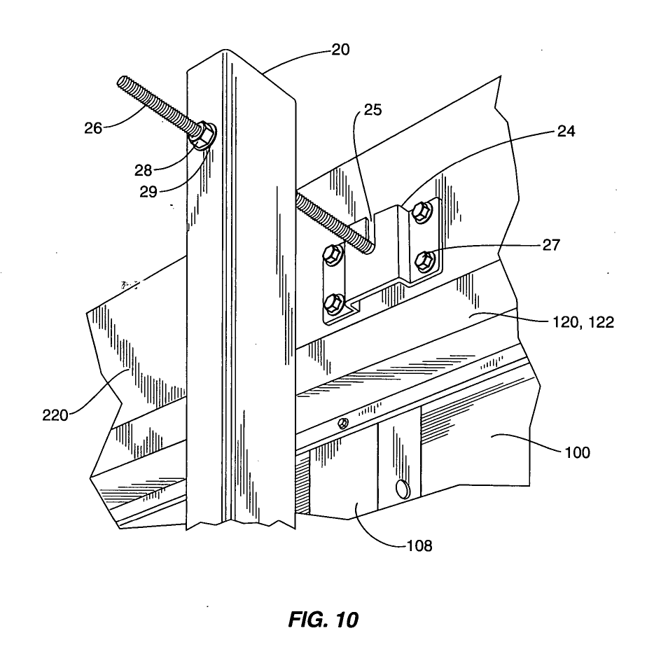

FIG. 10 shows one arrangement for attaching the upper end of the post to the header 220 above the door 100. In this arrangement, a header bracket 24 is affixed to the header 220, such as by a plurality of threaded fasteners 27. The bracket includes a central open-ended slot 25 sized to receive the shank of a carriage bolt 26, such that the head (not shown) of the carriage bolt 26 is captured by the header bracket 24. The threaded shank of the carriage bolt 26 extends through aligned openings in opposed walls of the hollow post 20. As shown in FIGS. 2 and 9, nuts 28 and washers 29 are engaged on the carriage bolt to secure the top end of the post 20 at a desired distance from the header 220. The header bracket 24 and carriage bolt 26 combine to fix the upper end of the post 20 in the entryway.

The vertical post reinforcement system 10 can easily be removed from an entryway when there is no imminent threat of high wind or pressure loads. First, the cables 60 are freed from the cable brackets 30 by removing the clevis pins 80 from the brackets. The lower end of the post 20 is released by manually removing the eyebolt 50 without tools. Once the lower end of the post 20 is freed, the carriage bolt 26 can be easily disengaged from the header bracket 24 by lifting the post 20, and slidably disengaging the carriage bolt 26 from the open-ended slot 25 in the header bracket 24. Accordingly, the system 10 can be removed from an entryway without the use of tools, and can be conveniently reinstalled in an entryway without tools.

Because the cables 60 are captured on the post 20 by the cable clips 68, and because the carriage bolt 26 and eyebolt 50 also are attached to the post 20, the system 10 includes no small loose parts when disassembled from an entryway. In addition, the cable brackets 30 and clevis pins 80 are securely retained on the door panels 102, 104, 106. Accordingly, there is substantially no risk of losing or misplacing essential small parts when the system 10 is not in use.

The above description of various embodiments of the invention is provided to describe various details and aspects of the invention, and is not intended to limit the invention thereto. A person of ordinary skill in the art will understand that various modifications may be made to the described embodiments without departing from the scope of the invention. All such modifications are intended to be within the scope of the appended claims.

What is claimed is:

1. A reinforcement system for a sectional overhead door having a plurality of pivotally interconnected door panels, the system comprising:
(a) a post having a lower end;
(b) an anchor for removably connecting the lower end of the post to a floor, the anchor comprising:
(i) a bracket having a vertical leg configured to be removably attached to the lower end of the post, and a horizontal leg; and
(ii) an eyebolt configured to removably attach the horizontal leg of the L-bracket to the floor, the eyebolt being movably attached to the post;
(c) a plurality of door brackets configured for attachment to the door panels, each bracket comprising a first wall having at least a pair of first openings therein, and an opposed second wall having at least a pair of second openings therein, and a selectively positionable clevis pin removably extending through opposed first and second openings; and
(e) a plurality of cables, each cable having first and second ends configured to be removably engaged around the clevis pin of one of the door brackets when the cable is wrapped around the vertical post.

2. A reinforcement system for a sectional overhead door according to claim 1, wherein the post has a hollow rectangular cross section.

3. A reinforcement system for a sectional overhead door according to claim 1, wherein each of the plurality of cables includes a first end having a first loop thereon and a second end having a second loop thereon, wherein the first and second loops are capable of receiving the pin of one of the door panel brackets.

4. A reinforcement apparatus for a sectional overhead door, the apparatus comprising:
(a) a vertical post having a lower end;
(b) an anchor comprising an anchor bolt configured to removably attach the post to a floor without tools; and
(c) a cable attaching the anchor bolt to the vertical post.

5. A reinforcement apparatus according to claim 4, wherein the anchor further comprises a bracket having a first leg attached to the lower end of the post, and a second leg having an aperture therethrough for receiving the anchor bolt.

6. A reinforcement apparatus according to claim 5 and further comprising an anchor plate configured to be attached to the floor, the anchor plate comprising a hole for receiving the anchor bolt.

7. A reinforcement apparatus according to claim 4 wherein the vertical post has a hollow rectangular cross section.

8. A reinforcement apparatus for a sectional overhead door including a plurality of pivotally interconnected door panels having inner faces, the apparatus comprising:
(a) a vertical post;
(b) at least one door panel bracket configured for attachment to a door panel of the overhead door, the door panel bracket comprising:
(i) a first plate having a plurality of spaced first openings therein;
(ii) a second plate in opposed spaced relation to the first plate and having a plurality of spaced second openings therein; and
(iii) a clevis pin removably extending between the first and second plates, wherein the pin is capable of extending through different pairs of the first and second openings;
(c) wherein the clevis pin of each door bracket is capable of being selectively positioned between the first and second plates such that the pin is positioned at a selected distance from the inner face of an associated door panel.

9. A reinforcement apparatus for a sectional overhead door according to claim 8, wherein the apparatus includes a plurality of door panel brackets, each door panel bracket being configured for attachment to one of the plurality of door panels.

10. A reinforcement apparatus for a sectional overhead door according to claim 8 wherein the pin includes a head on at least one end.

11. A reinforcement apparatus for a sectional overhead door according to claim 8 wherein the pin includes a hole therethrough proximate to one end of the pin, and further comprising a retainer removably extending through the hole.

12. A reinforcement apparatus for a sectional overhead door according to claim 8 and further comprising a plurality of elongated cables having first ends and second ends, wherein the first and second ends each are configured to be removably attached to a pin of one of the door panel brackets.

13. A reinforcement apparatus for a sectional overhead door according to claim 12, wherein the first and second ends of the cables each include a loop capable of receiving the pin of the door panel bracket therethrough.

14. A reinforcement apparatus for a sectional overhead door according to claim 12 wherein the vertical post has a hollow rectangular cross-section.

15. A method of adapting a vertical post reinforcement system including a vertical post to overhead sectional doors having door panels with inner faces and various overall depths, the method comprising:
(a) providing a plurality of elongated cables, each cable having opposed ends and a fixed length;
(b) providing adjustable cable connection means for connecting the cables to the door panels of the overhead sectional door, wherein the adjustable cable connection means permits the ends of the cables to be connected to the door panels at a selected distance from the inner faces of the door panels.

16. A method according to claim 15 and further comprising providing a vertical post mounting means, wherein the mounting means is configured to permit a person to manually mount the vertical post in an entryway without tools.

17. A method according to claim 16 wherein the adjustable cable connection means comprises a plurality of door panel brackets having selectively positionable pins capable of being selectively positioned in at least two different positions relative to the inner faces of the door panels.

18. A reinforcement apparatus for a sectional overhead door having a plurality of door panels with inner faces, the apparatus comprising:
(a) a vertical post having an upper end and a lower end;
(b) lower end anchoring means for removably anchoring the lower end of the vertical post to a floor without tools;
(c) a plurality of cables for binding the door panels to the vertical post; and
(d) adjustable cable connection means for connecting the cables to the door panels of the sectional overhead door, wherein the adjustable cable connection means permits ends of the cables to be connected to the door panels at a selected distance from the inner faces of the door panels.

19. A reinforcement apparatus according to claim 18 wherein the lower end anchoring means comprises an anchor bolt movably attached to the vertical post.

20. A reinforcement apparatus according to claim 18 wherein the adjustable cable connection means comprises a plurality of door panel brackets, each door panel bracket comprising a repositionable pin that is connectable to ends of the cables.
